(19) United States
(12) Patent Application Publication
(10) Pub. No.: US 2014/0032602 A1
(43) Pub. Date: Jan. 30, 2014

(54) In-Memory Database Interface To Respect Assigned Authorization Profiles

(71) Applicant: Hans-Christian Humprecht, Heidelberg-Ziegelhausen (DE)

(72) Inventor: Hans-Christian Humprecht, Heidelberg-Ziegelhausen (DE)

(73) Assignee: SAP AG, Walldorf (DE)

(21) Appl. No.: 13/559,202

(22) Filed: Jul. 26, 2012

(51) Int. Cl. G06F 17/30

(52) U.S. Cl. 707/784; 707/E17.005

(57) ABSTRACT

A system, method, and a computer program product for checking in-memory authorization profiles are disclosed. An authorization profile of a user in an enterprise resource planning system can be determined. An access to an in-memory database system can be requested based on the determined authorization profile. Based on the access request, an authorization check of the determined authorization profile of the user can be performed to determine whether the user can access the in-memory database system using the determined authorization profile. An access to the in-memory database system to the user can be granted based on the performed authorization check.

### TECHNICAL FIELD

This disclosure relates generally to data processing and, in particular, to authorization profiles in in-memory databases.

### BACKGROUND

An in-memory database is a database management system that primarily relies on main memory for computer data storage. In-memory database system can allow faster access to data and reduction of I/O reading activity when querying the data. In applications where response time is critical, such as telecommunications network equipment and mobile ads networks, main memory databases can be used.

An example of such in-memory database is a High Performance Analytic Appliance (“HANA”) has been developed by SAP AG, Walldorf, Germany. HANA can provide processing, storage, and/or access to various business content, transactional data, business process data, and/or any other type of data. HANA can take advantage of the low cost of main memory (e.g., Random Access Memory (“RAM”)), data processing abilities of multi-core processors and the fast data access of solid-state drives relative to traditional hard drives to deliver better performance of analytical and transactional applications. It can provide a multi-engine query processing environment that can support both row- and column-oriented physical representations in a hybrid engine as well as graph and text processing for semi- and unstructured data management within the same system.

A database system can have an authorization design time. Such authorization design time can enable a system administrator to grant privileges to or generate various authorization profiles for a particular user. In case of HANA, the administrator can use HANA's authorization tools to grant such privileges to users and to define privileges for each data column. The content can come from any transactional systems that can communicate with HANA. However, each such transaction system, e.g., enterprise resource planning (“ERP”) system, supply chain management system (“SCM”) system, supplier relationship management (“SRM”) system, customer relationship management (“CRM”) system, can have its own authorization design times and/or appropriate privileges/profiles for its users. Such privileges/profiles may not valid when a user is seeking to access an in-memory database, such as HANA. Thus, a separate authorization privilege/profile may need to be generated for the user seeking access to an in-memory database. This creates additional computing time, delays processing and access by the user to data as well as increases total cost ownership of systems implemented by the user.

### SUMMARY

In some implementations, the current subject matter relates to a computer-implemented method. The method can include determining an authorization profile of a user in an enterprise resource planning system, requesting, based on the determined authorization profile, an access to an in-memory database system, performing, based on the access request, an authorization check of the determined authorization profile of the user to determine whether the user can access the in-memory database system using the determined authorization profile, and granting, based on the performed authorization check, an access to the in-memory database system to the user. At least one of the determining, the requesting, the performing, and the granting can be performed on at least one processor.

In some implementations, the current subject matter can include one or more of the following optional features. The authorization profile of the user can be associated with at least one restriction, wherein the at least one restriction limits access of the user to the at least one of the enterprise resource planning system and the in-memory database system. At least one restriction can be associated with at least one of the following: a business process, a time, user authorization role in the enterprise resource planning system, an application being called by the user in the enterprise resource planning system, and the user.

In some implementations, performance of an authorization check can include generating a checklist of restrictions for limiting access of the user to the in-memory database system and comparing the determined user authorization profile with the restrictions on the generated checklist to determine whether the user can be granted access to the in-memory database system based on the determined user authorization profile. Performance of an authorization check can also include generating an authorization interface for obtaining the determined authorization profiled of the user in the enterprise resource planning system. Generation of an authorization interface can include generating an in-memory database view for checking the determined user authorization profile to determine whether to grant access to the user based on the determined user authorization profile.

The in-memory database system can be a high performance analytic appliance system.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary system including a data storage application, according to some implementations of the current subject matter;

FIG. 2 is a diagram illustrating details of the system of FIG. 1;

FIG. 3 is a diagram illustrating an exemplary database access procedure via an application server;

FIG. 4 is a diagram illustrating an exemplary database access procedure via an open database connectivity;

FIG. 5 is a diagram illustrating an exemplary procedure for performing an authorization check for a user attempting to access an in-memory database system, according to some implementations of the current subject matter;

FIG. 6 illustrates an exemplary HANA DB view AUTH_VAL for in-memory database view directly reading the authorization data, according to some implementations of the current subject matter;

FIG. 7 illustrates an exemplary reading of authorization value in HANA, according to some implementations of the current subject matter;

FIG. 8 is an exemplary system, according to some implementations of the current subject matter; and

FIG. 9 is an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for providing an ability to reuse authorization profiles in in-memory databases.

In some implementations, the current subject matter can be implemented in various in-memory database systems that can require its users to have authorization profiles for the purposes of accessing data in such systems. As stated above, an example of such in-memory database systems includes HANA system as developed by SAP AG, Walldorf, Germany. Various systems, such as, ERP system, SCM system, SRM system, CRM system, and/or others, can interact with the in-memory system for the purposes of accessing data, for example. The following is a discussion of an exemplary in-memory system.

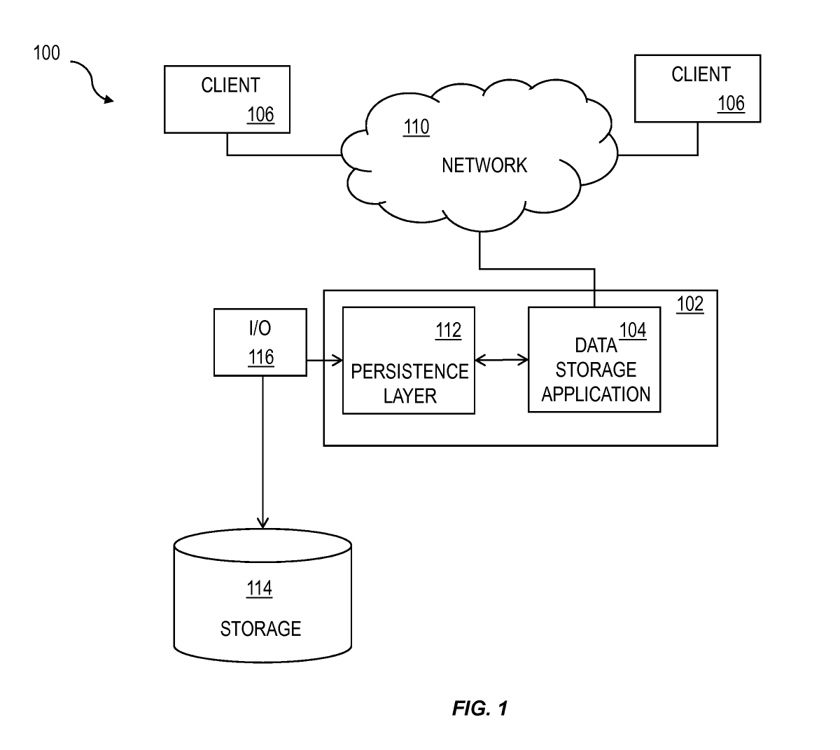

FIG. 1 illustrates an exemplary system 100 in which a computing system 102, which can include one or more programmable processors that can be collocated, linked over one or more networks, etc., executes one or more modules, software components, or the like of a data storage application 104, according to some implementations of the current subject matter. The data storage application 104 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 102 as well as to remote users accessing the computing system 102 from one or more client machines 106 over a network connection 110. One or more user interface screens produced by the one or more first modules can be displayed to a user, either via a local display or via a display associated with one of the client machines 106. Data units of the data storage application 104 can be transiently stored in a persistence layer 112 (e.g., a page buffer or other type of temporary persistency layer), which can write the data, in the form of storage pages, to one or more storages 114, for example via an input/output component 116. The one or more storages 114 can include one or more physical storage media or devices (e.g. hard disk drives, persistent flash memory, random access memory, optical media, magnetic media, and the like) configured for writing data for longer term storage. It should be noted that the storage 114 and the input/output component 116 can be included in the computing system 102 despite their being shown as external to the computing system 102 in FIG. 1.

Data retained at the longer term storage 114 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

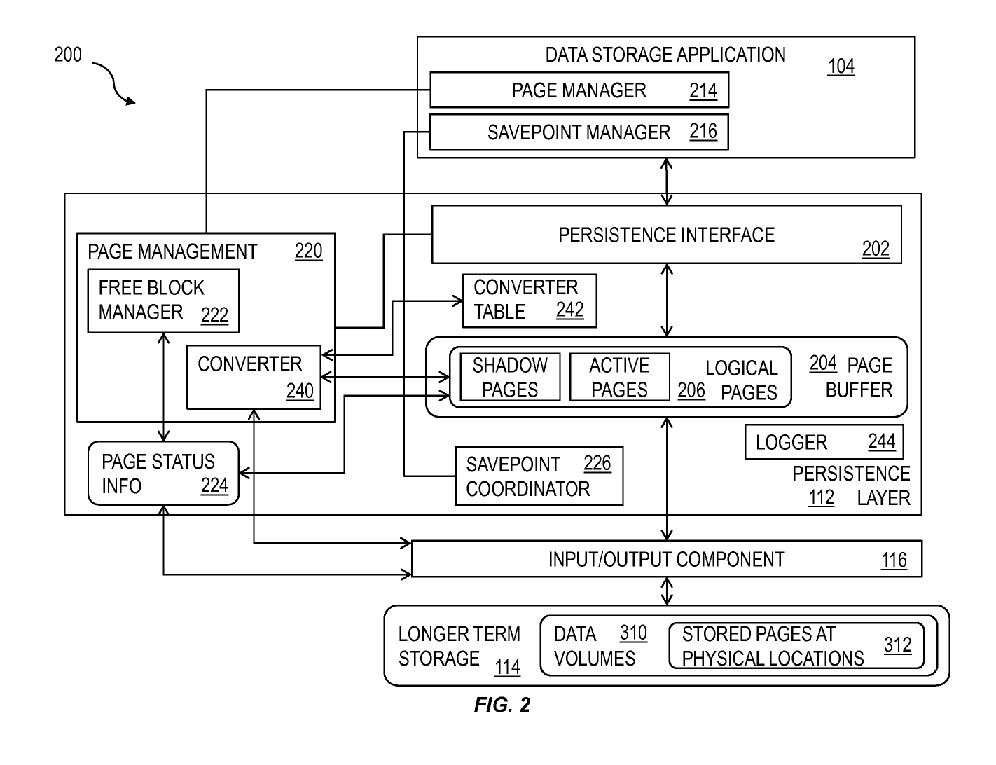

FIG. 2 illustrates an exemplary software architecture 200, according to some implementations of the current subject matter. A data storage application 104, which can be implemented in one or more of hardware and software, can include one or more of a database application, a network-attached storage system, or the like. According to at least some implementations of the current subject matter, such a data storage application 104 can include or otherwise interface with a persistence layer 112 or other type of memory buffer, for example via a persistence interface 202. A page buffer 204 within the persistence layer 112 can store one or more logical pages 206, and optionally can include shadow pages, active pages, and the like. The logical pages 206 retained in the persistence layer 112 can be written to a storage (e.g. a longer term storage, etc.) 114 via an input/output component 116, which can be a software module, a sub-system implemented in one or more of software and hardware, or the like. The storage 114 can include one or more data volumes 210 where stored pages 312 are allocated at physical memory blocks.

In some implementations, the data storage application 104 can include or be otherwise in communication with a page manager 214 and/or a savepoint manager 216. The page manager 214 can communicate with a page management module 220 at the persistence layer 112 that can include a free block manager 222 that monitors page status information 224, for example the status of physical pages within the storage 114 and logical pages in the persistence layer 112 (and optionally in the page buffer 204). The savepoint manager 216 can communicate with a savepoint coordinator 226 at the persistence layer 112 to handle savepoints, which are used to create a consistent persistent state of the database for restart after a possible crash.

In some implementations of a data storage application 104, the page management module of the persistence layer 112 can implement a shadow paging. The free block manager 222 within the page management module 220 can maintain the status of physical pages. The page buffer 204 can included a fixed page status buffer that operates as discussed herein. A converter component 240, which can be part of or in communication with the page management module 220, can be responsible for mapping between logical and physical pages written to the storage 114. The converter 240 can maintain the current mapping of logical pages to the corresponding physical pages in a converter table 242. The converter 240 can maintain a current mapping of logical pages 206 to the corresponding physical pages in one or more converter tables 242. When a logical page 206 is read from storage 114, the storage page to be loaded can be looked up from the one or more converter tables 242 using the converter 240. When a logical page is written to storage 114 the first time after a savepoint, a new free physical page is assigned to the logical page. The free block manager 222 marks the new physical page as “used” and the new mapping is stored in the one or more converter tables 242.

The persistence layer 112 can ensure that changes made in the data storage application 104 are durable and that the data storage application 104 can be restored to a most recent committed state after a restart. Writing data to the storage 114 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 244 can also be included to store the changes made to the data of the data storage application in a linear log. The logger component 244 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 244 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 112 can use a combination of undo log entries (from one or more logs) and shadow paging.

The persistence interface 202 can handle read and write requests of stores (e.g., in-memory stores, etc.). The persistence interface 202 can also provide write methods for writing data both with logging and without logging. If the logged write operations are used, the persistence interface 202 invokes the logger 244. In addition, the logger 244 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 244. For an entry of type “update”, for example, this would be the identification of the affected record and the after image of the modified data.

When the data application 104 is restarted, the log entries need to be processed. To speed up this process the redo log is not always processed from the beginning Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 244 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 244 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 244 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 104 can use shadow paging so that the savepoint manager 216 can write a transactionally-consistent savepoint. With such an arrangement, a data backup comprises a copy of all data pages contained in a particular savepoint, which was done as the first step of the data backup process. The current subject matter can be also applied to other types of data page storage.

In some implementations, the current subject matter relates to systems and methods for reusing authorization concepts of users in various systems, such as, for example, an in-memory database system and an enterprise resource planning (“ERP”) system or any other system. For illustrative purposes only, the following discussion will describe reusing authorization concepts by an in-memory database system and an ERP system. Reuse of authorization concepts can reduce total cost of ownership, reduce processing time, increase speed of access to data, as well as have any other advantages.

To access a particular application and/or data, an administrator of a system which includes the application and/or data can grant and/or assign to a user seeking to access such application and/or data appropriate authorization profile and/or authorization role. Such authorization profile and/or authorization role can be stored in a database and/or any other memory and can be called up when the user wishes to access the application and/or data again. The authorization data associated with the authorization profile and/or authorization role can include an identification of the particular role assigned to the user in connection with this authorization, name of the user, date and time the authorization has been granted, profile name, status of the authorization, validity period during which the granted authorization can be deemed valid, name of the authorization, identification of rights that can be granted to the authorized user associated with the authorization profile and/or authorization role. The authorization profile and/or authorization role information can be based on authorization objects that can include various database fields containing the authorization information. A database field can be represented by an in-memory database column and can include a name of a transaction, a report, information about a cost center, cost element, controlling area, as well as any other information that can be relevant to a business transaction, report, business process, data, or any other information.

In some implementations, an administrator of the system to which the user seeks access can be provided with authorization user interface that can include various sections (e.g., that can be represented by tabs), which the administrator can use to fill in appropriate information about the user seeking authorization to a particular application and/or data. The sections can correspond to the database fields seeking information about the user (e.g., description of the authorization role, validity period of the authorization, etc.). In some implementations, the administrator can manually fill out information in each of these fields. Alternatively, the database fields can be automatically populated with user-specific information. This can be done based on the information provided by the user (e.g., login information, name, address, etc.) and/or stored information.

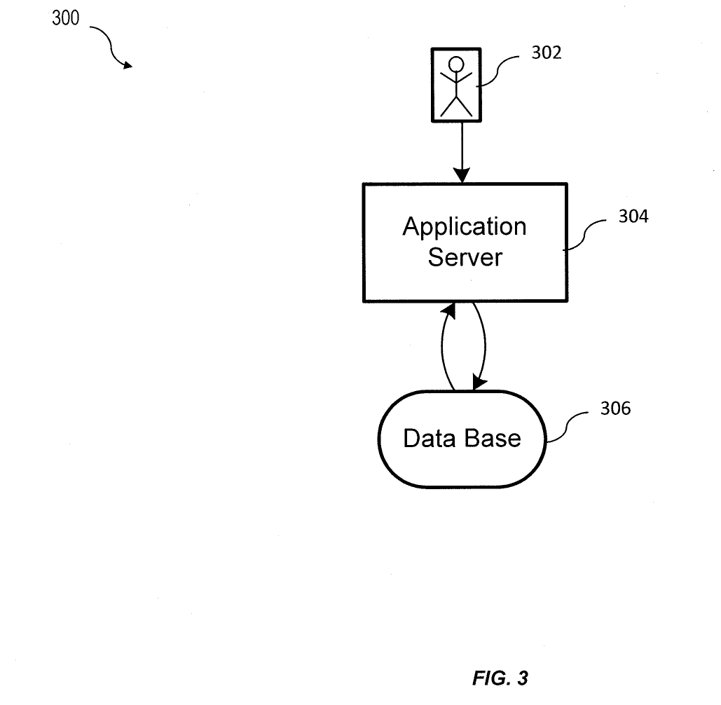

Upon completion of the authorization process, the authorization information can be stored in a table and/or any other format. Once the authorization information is stored, the user having the assigned stored authorization information can access on an application and/or data, whereby the system, prior to granting access to the user, can process the user's stored authorization information and determine whether or not to allow the user to have access to the application and/or data. In some implementations, the processing of the authorization role can run as a specific functionality on an application server, as shown in FIG. 3.

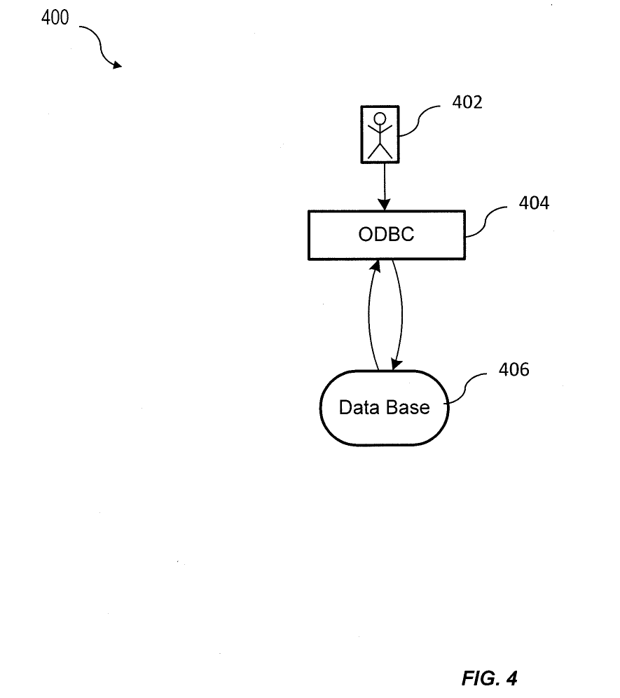

As shown in FIG. 3, the system 300 can perform an authorization check, where a user 302 attempting to access a specific database 306 via an application server 304. The user authorization check can be performed by the systems, such an ERP system, as well as by in-memory databases, such as the HANA system. FIG. 4 illustrates an exemplary authorization check procedure 400 for accessing in-memory database system. A user 402 can attempt to access database 406 via Open Database Connectivity (“ODBC”) 404. Prior to allowing user to access the in-memory database 406, an authorization check procedure can be performed by the database 406. In some implementations, the current subject matter can reuse the authorization information (e.g., user role, user profile, etc.) that has been generated by one system in the other system. For example, authorization information for the user generated by the ERP system can be used by the in-memory database to provide access to the user to the application and/or data.

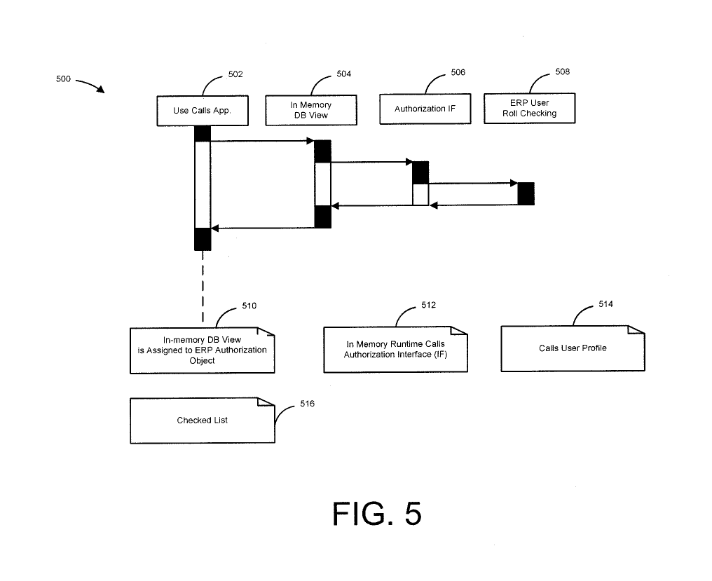

FIG. 5 illustrates an exemplary system 500 for reusing authorization information generated by a system (e.g., ERP system) in another system (e.g., an in-memory database system, such as SAP AG's HANA system), according to some implementations of the current subject matter. At 502, a user can call on an application. The call can be directly issued by the user or another application can call on the application. At 504, an in-memory database view can be generated. The in-memory database view can be assigned to the authorization object associated with the application that has been called by the user, at 510.

At 506, an authorization interface is generated. User authorization profile and/or authorization role can be checked via an in-memory runtime view by using the authorization interface, at 512. The authorization interface can be a technical abstraction between the in-memory database runtime and an in-memory database authorization manager. The authorization interface can allow an administrator to organize all activities associated with the application call in one place. The administrator can also restrict access to the in-memory database through registration of calculation views and analytical privileges associated with the user. Restrictions can be defined to specify whether the in-memory database view can be generated. They can also specify various ranges of values that can be related to authorization. Access to in-memory database can be also restricted using various attributes (e.g., value filters “EQUAL”, “BETWEEN”, etc.). Additionally, validity restriction can be used to restrict access. Such restrictions can specify a valid time range during which access can be granted/restricted to the in-memory database. An exemplary validity restriction can include: GREATER THAN 2012/05/18:10:01:000. Cube restrictions can allow usage of CONTAINS PATTERN operations. Activity restrictions can be used to specify that the user can READ a HANA view. This means that a user can obtain a right to perform READ via database view one or more columns. Other activity can include a database INSERT. Further, column views can be created using SQL (e.g., CREATE COLUMN VIEW <xy> WITH PARAMETERS . . . ). As such, it can be possible to specify a parameter, REGISTERVIEWFORAPCHECK to indicate if the view that is to be created can also be registered for analytical privilege check. The name and attributes of views can be required to perform an authorization check. Also, restrictions can specify whether the user is allowed to perform the view and can define a range of values.

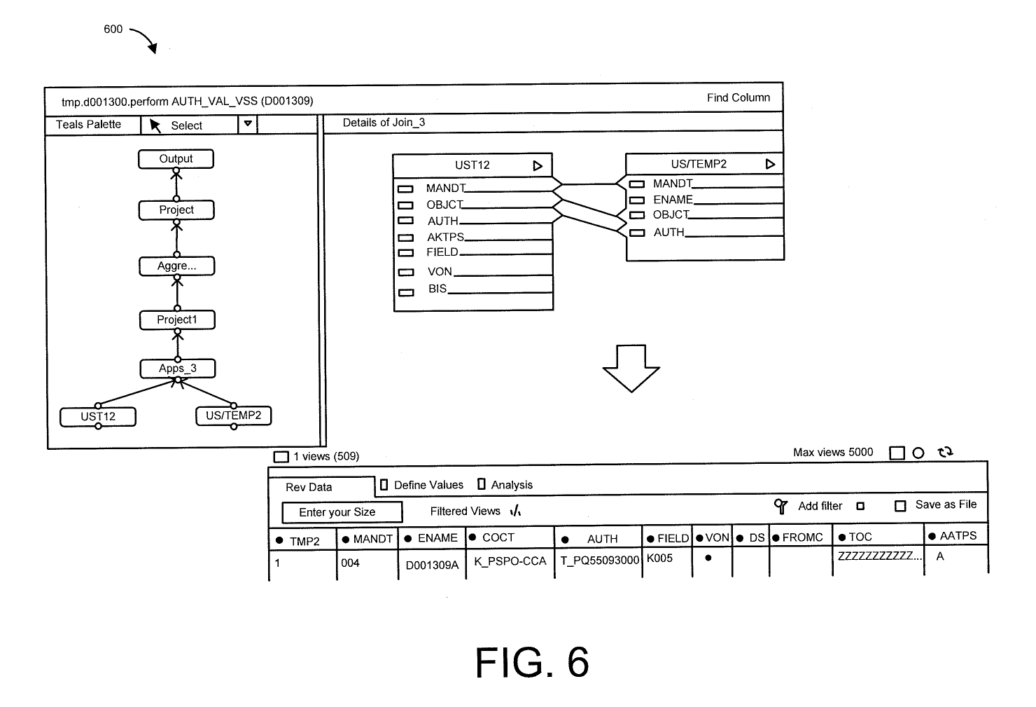

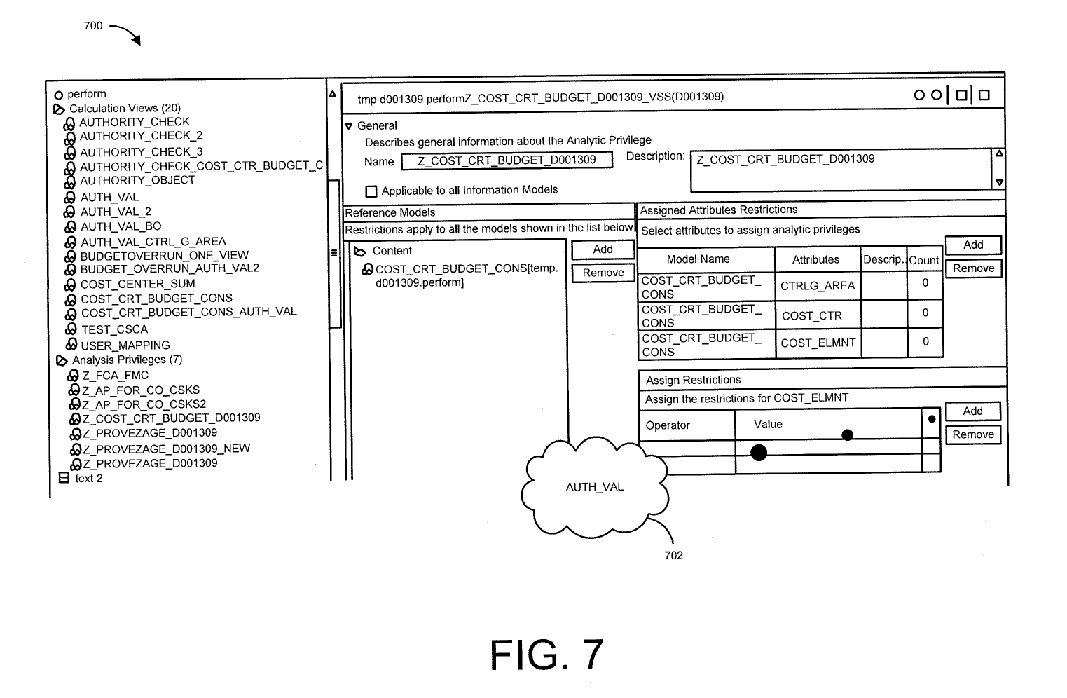

In some implementations, analytical authorizations can be built using analytical privilege(s) and analytical view(s). The privileges can contain a set of restrictions against which user's access can be verified. In this case, a restriction can include a set of value filters. The filters can be defined by the administrator and include an array of operands as parameters for the administrator. The value filter can also define an authorization check, which can be used to verify data access for the user. The authorization interface can perform such authorization check of the user' authorization. In SAP AG's HANA system, this check can be implemented using a HANA DB view AUTH_VAL code. An exemplary DB view AUTH_VAL 600 is shown in FIG. 6. The DB view AUTH_VAL 600 contains a set of existing authorization values as well as additional authorization values that can be used to filter data set(s) directly during HANA run time. For example, the code can include three attribute fields CONTROLING_AREA, COST_CENTER, and COST_ELEMENT, which can be used as restrictions, as shown in FIG. 7. The AUTH_VAL 702 indicates that the HANA view AUTH_VAL reads the authorization values. The fields can also be part of a technical authorization object, which can be assigned to one or more authorization roles, where the role can be assigned to the user.

In some implementations, the AUTH_VAL consumption can be performed as a HANA script view, as indicated below:

```
/********* Begin Procedure Script ************/
BEGIN
  var_out = select CO.kostl, CO.ktext, CO.wtg001, AU.fromc_kostl,
AU.toc_kostl from “xy”.“test/CO_COSP_KOSTL” as CO
      join “xy”.“test/AUTH_VAL” as AU on CO.kostl between
AU.fromc_kostl and AU.toc_kostl;
END /********* End Procedure Script ************/
```

The field “kost1” can be a technical name of a “Cost Center.” The field “fromc_kost1” and field “toc_kost1” can contain “FROM”, “TO” values, respectively, for filtering the result list. In the event that more than one authorization check fields like “Cost Center,” “Controlling Area,” “Cost Element” and more than one profile, the check can be complex. In some implementations, a pattern for reusing ERP profile values can be as follows: multiple restrictions for one attribute can be combined with an OR (see, e.g., line 3 in the table below), and multiple values for different attributes can be combined with an AND (see, e.g., lines 1, 2, and 3 in the table below).

The following table illustrates exemplary dependencies:

| | HANA Attr. Cost | HANA Attr. | HANA Attr. Cost |
|---|---|---|---|
| | Center Field: | Controlling Area | Element |
| Profile | “KOSTL” | Field: “KOKRS” | Field: “KSTAR” |
| 1 | 1000 | 100 | 65000 |
| 2 | 2000 | 200 | 85000 |
| 3 | 3000, 4000 | 300 | 95000 |

The following illustrates an exemplary filter statement that can map profile content:

```
SELECT CO.kostl,CO.kokrs,CO.kstar from “schema1”.test/CO_COSP
where (“xy.CO_COSP”.“KOSTL”=’1000’ AND
“xy.CO_COSP”.”KOKRS”=’100’ AND
“xy.CO_COSP”.”KSTAR”=”65000”) OR
  (“xy.CO_COSP”.“KOSTL”=’2000’ AND
“xy.CO_COSP”.”KOKRS”=’200’ AND
“xy.CO_COSP”.”KSTAR”=”85000”) OR
  (“xy.CO_COSP”.“KOSTL” = (3000 OR 4000) AND
“xy.CO_COSP”.”KOKRS”=’300’ AND
“xy.CO_COSP”.”KSTAR”=”95000”)
```

where “xy” can be a name of a HANA scheme. UST12 can be a name of a database table that can contain profile values. CO_COSP can be a name of an exemplary database view. CO_COSP can read costing positions. The exemplary script above can represent a set of privileges for the database view and can arise from at least one underlying profile. Multiple profiles for one user and view(s) can receive multiple privileges that can be combined with a logical OR.

In some implementations, a customer can maintain the privileges manually. For example, the customer can create three privileges, one privilege for each profile, based on the table illustrated above. In some implementations, a privilege can be assigned to HANA user and a productive database view to user. Here, the user can receive privileges and content. Content can be one or more database view. If the user name in the ERP, etc. is different from the user names in HANA, then a user mapping can be implemented.

Subsequent to the generation of the authorization interface, the user authorization role in the ERP system can be checked, at 508. This can be accomplished by performing authorization checks against user profile, at 514. Various restrictions can also be checked to determine whether the user can be granted access to the in-memory database system (e.g., SAP AG's HANA system) based on the user profile in the ERP system. Once the authorization check is completed, a checked list of various authorization fields, attributes, values, restriction, as well as any other parameters can be generated, at 516. Based on the generated check list, the system 500 can determine whether or not to grant the user access to the in-memory database system based on the user's authorization profile and/or authorization role in the ERP system. In some implementations, once the user is allowed access to the in-memory database system based on the user's authorization profile and/or authorization role in the ERP system, the user can continue to have access to the in-memory database system without repeating the authorization procedure.

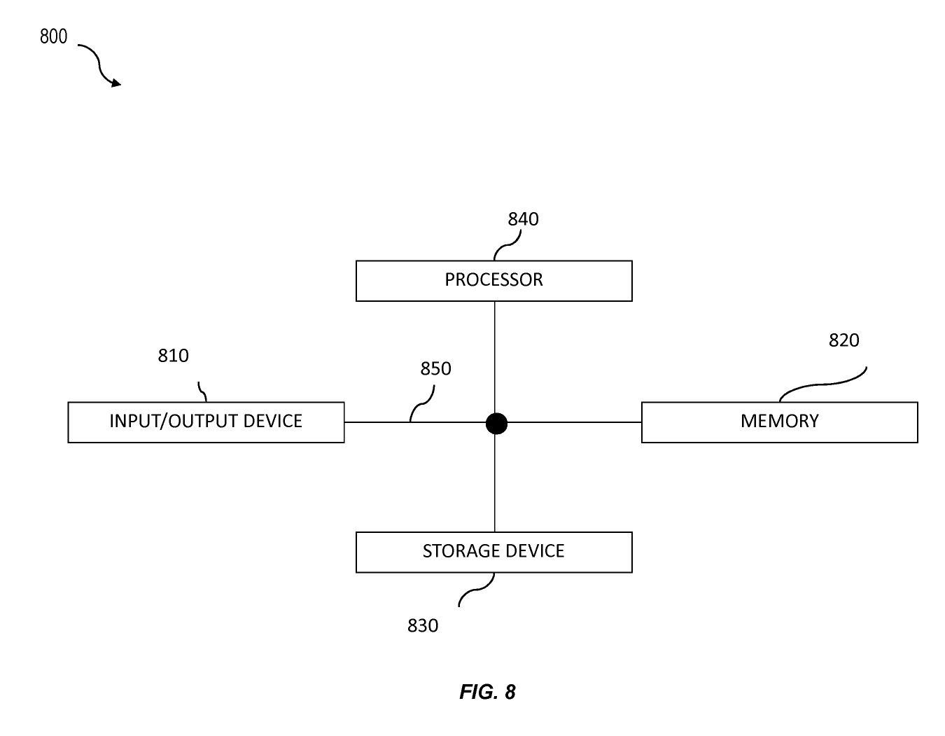

In some implementations, the current subject matter can be configured to be implemented in a system 800, as shown in FIG. 8. The system 800 can include a processor 810, a memory 820, a storage device 830, and an input/output device 840. Each of the components 810, 820, 830 and 840 can be interconnected using a system bus 850. The processor 810 can be configured to process instructions for execution within the system 800. In some implementations, the processor 810 can be a single-threaded processor. In alternate implementations, the processor 810 can be a multi-threaded processor. The processor 810 can be further configured to process instructions stored in the memory 820 or on the storage device 830, including receiving or sending information through the input/output device 840. The memory 820 can store information within the system 800. In some implementations, the memory 820 can be a computer-readable medium. In alternate implementations, the memory 820 can be a volatile memory unit. In yet some implementations, the memory 820 can be a non-volatile memory unit. The storage device 830 can be capable of providing mass storage for the system 800. In some implementations, the storage device 830 can be a computer-readable medium. In alternate implementations, the storage device 830 can be a floppy disk device, a hard disk device, an optical disk device, a tape device, non-volatile solid state memory, or any other type of storage device. The input/output device 840 can be configured to provide input/output operations for the system 800. In some implementations, the input/output device 840 can include a keyboard and/or pointing device. In alternate implementations, the input/output device 840 can include a display unit for displaying graphical user interfaces.

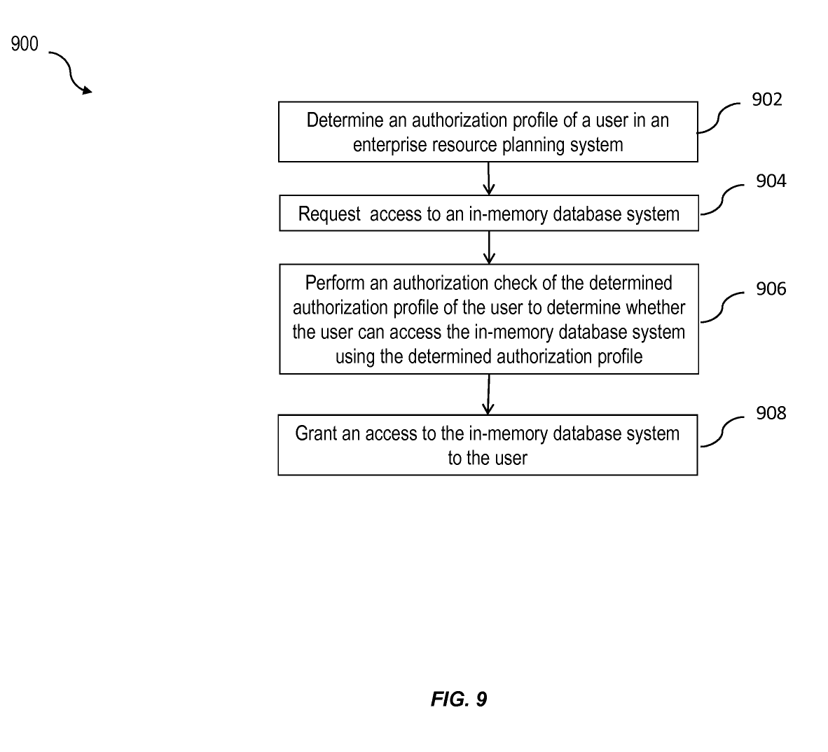

FIG. 9 illustrates an exemplary method, according to some implementations of the current subject matter. At 902, an authorization profile of a user in an enterprise resource planning system can be determined. At 904, an access to an in-memory database system can be requested based on the determined authorization profile. At 906, based on the access request, an authorization check of the determined authorization profile of the user can be performed to determine whether the user can access the in-memory database system using the determined authorization profile. At 908, an access to the in-memory database system to the user can be granted based on the performed authorization check. At least one of the determining, the requesting, the performing, and the granting can be performed on at least one processor.

In some implementations, the current subject matter can include at least one or more of the following optional features. The authorization profile of the user can be associated with at least one restriction. At least one restriction can limit access of the user to the at least one of the enterprise resource planning system and the in-memory database system. At least one restriction can be associated with at least one of the following: a business process, a time, user authorization role in the enterprise resource planning system, an application being called by the user in the enterprise resource planning system, and the user.

Performance of the authorization check can also include generating a checklist of restrictions for limiting access of the user to the in-memory database system and comparing the determined user authorization profile with the restrictions on the generated checklist to determine whether the user can be granted access to the in-memory database system based on the determined user authorization profile. Performance can also include generating an authorization interface for obtaining the determined authorization profiled of the user in the enterprise resource planning system. Generation of the authorization interface can include generating an in-memory database view for checking the determined user authorization profile to determine whether to grant access to the user based on the determined user authorization profile.

The in-memory database system can be a high performance analytic appliance system.

The current subject matter can include at least one of the following optional features.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
determining an authorization profile of a user in an enterprise resource planning system;
requesting, based on the determined authorization profile, an access to an in-memory database system;
generating an authorization interface separate from the enterprise resource planning system for obtaining the determined authorization profiled of the user in the enterprise resource planning system;
performing, via the authorization interface and based on the access request, an authorization check of the determined authorization profile of the user to determine whether the user can access the in-memory database system using the determined authorization profile; and
granting, based on the performed authorization check, an access to the in-memory database system to the user;
wherein the at least one of the determining, the requesting, the performing, and the granting is performed on at least one processor.

2. The method according to claim 1, wherein the authorization profile of the user is associated with at least one restriction, wherein the at least one restriction limits access of the user to the at least one of the enterprise resource planning system and the in-memory database system.

3. The method according to claim 2, wherein the at least one restriction is associated with at least one of the following: a business process, a time, user authorization role in the enterprise resource planning system, an application being called by the user in the enterprise resource planning system, and the user.

4. The method according to claim 2, further comprising:
generating a checklist of restrictions for limiting access of the user to the in-memory database system; and
comparing the determined user authorization profile with the restrictions on the generated checklist to determine whether the user can be granted access to the in-memory database system based on the determined user authorization profile.

5. (canceled)

6. The method according to claim 1, wherein the generating the authorization interface further comprises:
generating an in-memory database view for checking the determined user authorization profile to determine whether to grant access to the user based on the determined user authorization profile.

7. The method according to claim 1, wherein the in-memory database system is high performance analytic appliance system.

8. A non-transitory computer program product storing instructions that, when executed by at least one programmable processor, cause the at least one programmable processor to perform operations comprising:
determining an authorization profile of a user in an enterprise resource planning system;
requesting, based on the determined authorization profile, an access to an in-memory database system;
generating an authorization interface separate from the enterprise resource planning system for obtaining the determined authorization profiled of the user in the enterprise resource planning system;
performing, via the authorization interface and based on the access request, an authorization check of the determined authorization profile of the user to determine whether the user can access the in-memory database system using the determined authorization profile; and
granting, based on the performed authorization check, an access to the in-memory database system to the user.

9. The computer program product according to claim 8, wherein the authorization profile of the user is associated with at least one restriction, wherein the at least one restriction limits access of the user to the at least one of the enterprise resource planning system and the in-memory database system.

10. The computer program product according to claim 9, wherein the at least one restriction is associated with at least one of the following: a business process, a time, user authorization role in the enterprise resource planning system, an application being called by the user in the enterprise resource planning system, and the user.

11. The computer program product according to claim 9, wherein the performing further comprises
generating a checklist of restrictions for limiting access of the user to the in-memory database system; and
comparing the determined user authorization profile with the restrictions on the generated checklist to determine whether the user can be granted access to the in-memory database system based on the determined user authorization profile.

12. The computer program product according to claim 8, wherein the performing further comprises
generating an authorization interface for obtaining the determined authorization profiled of the user in the enterprise resource planning system.

13. The computer program product according to claim 8, wherein the generating the authorization interface further comprises
generating an in-memory database view for checking the determined user authorization profile to determine whether to grant access to the user based on the determined user authorization profile.

14. The computer program product according to claim 8, wherein the in-memory database system is high performance analytic appliance system.

15. A system comprising:
at least one programmable processor; and
a machine-readable medium storing instructions that, when executed by the at least one programmable processor, cause the at least one programmable processor to perform operations comprising:
determining an authorization profile of a user in an enterprise resource planning system;
generating an authorization interface separate from the enterprise resource planning system for obtaining the determined authorization profiled of the user in the enterprise resource planning system;
requesting, via the authorization interface eand based on the determined authorization profile, an access to an in-memory database system;
performing, based on the access request, an authorization check of the determined authorization profile of the user to determine whether the user can access the in-memory database system using the determined authorization profile; and
granting, based on the performed authorization check, an access to the in-memory database system to the user.

16. The system according to claim 15, wherein the authorization profile of the user is associated with at least one restriction, wherein the at least one restriction limits access of the user to the at least one of the enterprise resource planning system and the in-memory database system.

17. The system according to claim 16, wherein the at least one restriction is associated with at least one of the following: a business process, a time, user authorization role in the enterprise resource planning system, an application being called by the user in the enterprise resource planning system, and the user.

18. The system according to claim 16, wherein the performing further comprises
generating a checklist of restrictions for limiting access of the user to the in-memory database system; and
comparing the determined user authorization profile with the restrictions on the generated checklist to determine whether the user can be granted access to the in-memory database system based on the determined user authorization profile.

19. (canceled)

20. The system according to claim 15, wherein the generating the authorization interface further comprises
generating an in-memory database view for checking the determined user authorization profile to determine whether to grant access to the user based on the determined user authorization profile.
